(19) United States
(12) Patent Application Publication
(10) Pub. No.: US 2008/0232486 A1
(43) Pub. Date: Sep. 25, 2008

(54) SYSTEMS AND METHODS FOR EXTENDING ZADOFF-CHU SEQUENCES TO A NON-PRIME NUMBER LENGTH TO MINIMIZE AVERAGE CORRELATION

(75) Inventor: John M. Kowalski, Camas, WA (US)

Correspondence Address: MADSON & AUSTIN, 15 WEST SOUTH TEMPLE, SUITE 900, SALT LAKE CITY, UT, 84101, US

(73) Assignee: Sharp Laboratories of America, Inc., Camas, WA (US)

(21) Appl. No.: 11/769,575

(22) Filed: Jun. 27, 2007

Related U.S. Application Data
(60) Provisional application No. 60/895,660, filed on Mar. 19, 2007.

(51) Int. Cl. H04L 27/26

(52) U.S. Cl. 375/260

(57) ABSTRACT

A method for mapping a reference signal is described. A reference signal with a first length is provided. A sequence with a second length is selected, wherein the second length is a prime number. The sequence is extended to a third length using an extension that is uniformly distributed over zero to 2π.

### RELATED APPLICATIONS

This application is related to and claims priority from U.S. Provisional Patent Application Ser. No. 60/895,660 filed Mar. 19, 2007, for SYSTEMS AND METHODS FOR EXTENDING ZADOFF-CHU SEQUENCES TO A NON-PRIME NUMBER LENGTH TO MINIMIZE AVERAGE CORRELATION, with inventor John M. Kowalski, which is incorporated herein by reference.

### TECHNICAL FIELD

The present invention relates generally to wireless communications and wireless communications-related technology. More specifically, the present invention relates to systems and methods that extend Zadoff-Chu sequences to a non-prime number length to minimize average correlation.

### BACKGROUND

A wireless communication system typically includes a base station in wireless communication with a plurality of user devices (which may also be referred to as mobile stations, subscriber units, access terminals, etc.). The base station transmits data to the user devices over a radio frequency (RF) communication channel. The term “downlink” refers to transmission from a base station to a user device, while the term “uplink” refers to transmission from a user device to a base station.

Orthogonal frequency division multiplexing (OFDM) is a modulation and multiple-access technique whereby the transmission band of a communication channel is divided into a number of equally spaced sub-bands. A sub-carrier carrying a portion of the user information is transmitted in each sub-band, and every sub-carrier is orthogonal with every other sub-carrier. Sub-carriers are sometimes referred to as “tones.” OFDM enables the creation of a very flexible system architecture that can be used efficiently for a wide range of services, including voice and data. OFDM is sometimes referred to as discrete multi-tone transmission (DMT).

The 3^{rd} Generation Partnership Project (3GPP) is a collaboration of standards organizations throughout the world. The goal of 3GPP is to make a globally applicable third generation (3G) mobile phone system specification within the scope of the IMT-2000 (International Mobile Telecommunications-2000) standard as defined by the International Telecommunication Union. The 3GPP Long Term Evolution (“LTE”) Committee is considering OFDM as well as OFDM/OQAM (Orthogonal Frequency Division Multiplexing/Offset Quadrature Amplitude Modulation), as a method for downlink transmission, as well as OFDM transmission on the uplink.

Wireless communications systems (e.g., Time Division Multiple Access (TDMA), Orthogonal Frequency-Division Multiplexing (OFDM)) usually calculate an estimation of a channel impulse response between the antennas of a user device and the antennas of a base station for coherent receiving. Channel estimation may involve transmitting known reference signals that are multiplexed with the data. Reference signals may include a single frequency and are transmitted over the communication systems for supervisory, control, equalization, continuity, synchronization, etc. Wireless communication systems may include one or more mobile stations and one or more base stations that each transmit a reference signal. Reference signals may be designed such that a mobile station may re-use a reference signal that was previously used by a different mobile station. However, correlation amongst reference signals may cause interference at a mobile station. As such, benefits may be realized from systems and methods that improve the design of reference signals for spatially multiplexed cellular systems. In particular, benefits may be realized from systems and methods that extend Zadoff-Chu sequences to a non-prime number length to minimize average correlation.

### BRIEF DESCRIPTION OF THE DRAWINGS

Exemplary embodiments of the invention will become more fully apparent from the following description and appended claims, taken in conjunction with the accompanying drawings. Understanding that these drawings depict only exemplary embodiments and are, therefore, not to be considered limiting of the invention's scope, the exemplary embodiments of the invention will be described with additional specificity and detail through use of the accompanying drawings in which:

FIG. 1 illustrates an exemplary wireless communication system in which embodiments may be practiced;

FIG. 2 illustrates some characteristics of a transmission band of an RF communication channel in accordance with an OFDM-based system;

FIG. 3 illustrates communication channels that may exist between an OFDM transmitter and an OFDM receiver according to an embodiment;

FIG. 4 illustrates one embodiment of a MIMO system that may be implemented with the present systems and methods;

FIG. 5 illustrates a block diagram of certain components in an embodiment of a transmitter;

FIG. 6 is a flow diagram illustrating one embodiment of a method for mapping a reference signal;

FIG. 7 illustrates an example of mapping a reference signal;

FIG. 8 is a chart illustrating a cumulative distribution function of cross-correlations between Zadoff-Chu sequences using uniformly distributed extensions; and

FIG. 9 illustrates various components that may be utilized in a communications device.

### DETAILED DESCRIPTION

A method for mapping a reference signal is described. A reference signal with a first length is provided. A sequence with a second length is selected. The second length is a prime number. The sequence is extended to a third length using an extension that is uniformly distributed over zero to 2π.

In one embodiment, the sequence is extended to a non-prime number using the extension that is uniformly distributed over zero to 2π. The second length may be less than the first length. The third length may be equal to the first length.

In one embodiment, the sequence is a Zadoff-Chu sequence. The sequence may be extended in a time domain representation of the sequence. In another embodiment, the sequence is extended in a frequency domain representation of the sequence. A first sequence may be extended with an extension that is uniformly distributed in phase from an extension of a second sequence. The sequence may be cyclically extended using the extension that is uniformly distributed over zero to 2π. A set of reference signals may be provided to cover a plurality of sectors of a cell.

A system that is configured to map a reference signal is also described. The system includes a processor and memory in electronic communication with the processor. Instructions are stored in the memory and are executable to provide a reference signal with a first length. The instructions are also executable to select a sequence with a second length, wherein the second length is a prime number. The instructions are further executable to extend the sequence to a third length using an extension that is uniformly distributed over zero to 2π.

A computer-readable medium comprising executable instructions for mapping a reference signal is also described. The instructions are executable to provide a reference signal with a first length and select a sequence with a second length, wherein the second length is a prime number. The instructions are further executable to extend the sequence to a third length using an extension that is uniformly distributed over zero to 2π.

Various embodiments of the invention are now described with reference to the Figures, where like reference numbers indicate identical or functionally similar elements. The embodiments of the present invention, as generally described and illustrated in the Figures herein, could be arranged and designed in a wide variety of different configurations. Thus, the following more detailed description of several exemplary embodiments of the present invention, as represented in the Figures, is not intended to limit the scope of the invention, as claimed, but is merely representative of the embodiments of the invention.

The word “exemplary” is used exclusively herein to mean “serving as an example, instance, or illustration.” Any embodiment described herein as “exemplary” is not necessarily to be construed as preferred or advantageous over other embodiments.

Many features of the embodiments disclosed herein may be implemented as computer software, electronic hardware, or combinations of both. To clearly illustrate this interchangeability of hardware and software, various components will be described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Where the described functionality is implemented as computer software, such software may include any type of computer instruction or computer executable code located within a memory device and/or transmitted as electronic signals over a system bus or network. Software that implements the functionality associated with components described herein may comprise a single instruction, or many instructions, and may be distributed over several different code segments, among different programs, and across several memory devices.

As used herein, the terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not necessarily all) embodiments of the disclosed invention(s)”, unless expressly specified otherwise.

The term “determining” (and grammatical variants thereof) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

Reference signals may be used in communication systems. Reference signals may include a single frequency and are transmitted over the communication systems for supervisory, control, equalization, continuity, synchronization, etc. Communication systems may include one or more mobile stations and one or more base stations that each transmit a reference signal. Reference signals may be designed such that a mobile station may re-use a reference signal that was previously used by a different mobile station or is used at the same time at another mobile station in another cell far enough apart so as to negligibly interfere. Truncation or cyclic extension of a particular set of Zadoff-Chu sequences has been utilized to design reference signals for re-use. In general, a plurality of sequences may be used in a cellular system to distinguish channels of a plurality of mobile stations at a base station receiver. Thus, it is desirable that these sequences be minimally correlated.

Truncation or cyclic extension of Zadoff-Chu sequences may result in a tedious integer programming problem for a sequence assignment. In addition, a guarantee of uniform correlation does not exist when truncation or cyclic extension of a particular set of Zadoff-Chu sequences are implemented. Further, because of variable correlation properties of candidate proposed reference signals, detailed planning regarding the mobile station may be done which may be particularly vexing if adjacent networks exist in the same band that are operated by different operators.

The present systems and methods design reference signals for multiple input multiple output (MIMO) systems in which reference signals are allocated amongst one or more mobile stations, for use in single user or multiple user MIMO systems. In one embodiment, the present systems and methods design uplink reference signals in a cellular system. Communications from mobile stations to base stations may be classified as “uplink” communications. Conversely, communications from base stations to mobile stations may be classified as “downlink” communications. Transmitting uplink reference signals in a cellular system may pose stringent requirements on time and frequency resources on the mobile station. These stringent requirements may impede an optimum design of the reference signals for the mobile station, which may desire to implement a single or multiple carrier modulation with cyclic prefix, where there is synchronization between the transmission of multiple uplink signals and their respective base stations and where sectorization amongst cells of mobile stations is employed to maximize the capacity per cell. In addition, the present systems and methods employ multiple bandwidth allocations simultaneously to multiple base stations. In one embodiment, each bandwidth segment allocated to a mobile station is an integer amount of some basic unit. Further, the present systems and methods minimize cross-correlation of a plurality of extended Zadoff-Chu sequences when the sequence length is not a prime number. The Zadoff-Chu sequences may be used to design reference signals that may be used in a cellular communication system.

In designing a set of reference signals, certain design considerations may be implemented. For example, the set may be large enough to cover at least three sectors per cell, with at least two reference signals per sector. In one embodiment, four reference signals per sector are present. A further design consideration may be that the set of reference signals may be orthogonal in each sector of a given cell. The set of reference signals may also be orthogonal in all sectors adjacent to a given sector. If the reference signals are orthogonal and the reference signals are known to adjacent sectors, a best minimum mean square receiver may be designed and implemented.

For those reference signals that are not in adjacent sectors, or which are not orthogonal, another design consideration may be that these reference signal are minimally correlated, with approximately the same correlation, and approach (if not meet) the Welch Bound. Sets of sequences that approach or meet the Welch Bound may denote a tight frame, where each vector possesses a unit norm, i.e., ∥ [symbol] ∥₂≡1. A further design consideration is the set of reference signals may also have a Peak to Average Power Ratio (PAPR) that approaches (if not equal) to 1. The PAPR may be defined as, for a sequence vector c as:

$$= \frac{{‖ c ‖}_{∞}^{2}}{{c}^{H} c} , \qquad ( Equation 1 )$$

where ∥c∥_{∞}² denotes the square maximum modulus component of c and where ( )^{H} denotes a conjugate transpose.

Another example of a design consideration may be that amongst subsets of sequences with orthogonal elements, each element may be a cyclic shift of another element. This property may be useful to provide robust performance if a transmission system which transmits a cyclic prefix for multipath elimination encounters multipath components with a delay spread greater than the cyclic prefix length. An additional design consideration is that in a system where multiple bandwidths are employed simultaneously, the set of reference signal sequences may be recursively generated from a base sequence.

In one embodiment, the amount of reference signal space (time and frequency resources) may be exactly large enough. For example, the basic unit of bandwidth allocation may allow for 19 or any larger prime number of reference signals available for two reference signals per sector. In a further example, the basic unit of bandwidth allocation may allow for 37 or any larger prime number of reference signals for four reference signals per sector. As in this case, if the amount of reference signal space is exactly large enough, Zadoff-Chu sequences may be taken as the reference sequences as they meet the design considerations previously described. However, such resource availability or sequence numerology may not be plausible.

When the sequence length of a Zadoff-Chu sequence is a prime number, its correlation properties may be such that the Welch Bound is achieved. This property is destroyed in general if the sequence length is not a prime number. In order to attempt to maintain the sequence properties, cyclic extension to a Zadoff-Chu sequence has been proposed. Through cyclic extension, the last sequence elements of the Zadoff-Chu sequence are obtained by cyclically extending the previous sequence elements from a prime numbered length sequence to a non-prime length sequence. However, cyclic extension does not minimize the average cross-correlation between multiple Zadoff-Chu sequences. The present systems and methods are directed to extending Zadoff-Chu sequences to a non-prime number length to minimize average correlation.

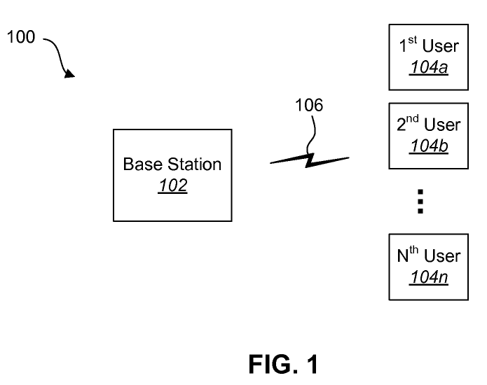

FIG. 1 illustrates an exemplary wireless communication system 100 in which embodiments may be practiced. A base station 102 is in wireless communication with a plurality of user devices 104 (which may also be referred to as mobile stations, subscriber units, access terminals, etc.). A first user device 104a, a second user device 104b, and an Nth user device 104n are shown in FIG. 1. The base station 102 transmits data to the user devices 104 over a radio frequency (RF) communication channel 106.

As used herein, the term “OFDM transmitter” refers to any component or device that transmits OFDM signals. An OFDM transmitter may be implemented in a base station 102 that transmits OFDM signals to one or more user devices 104. Alternatively, an OFDM transmitter may be implemented in a user device 104 that transmits OFDM signals to one or more base stations 102.

The term “OFDM receiver” refers to any component or device that receives OFDM signals. An OFDM receiver may be implemented in a user device 104 that receives OFDM signals from one or more base stations 102. Alternatively, an OFDM receiver may be implemented in a base station 102 that receives OFDM signals from one or more user devices 104.

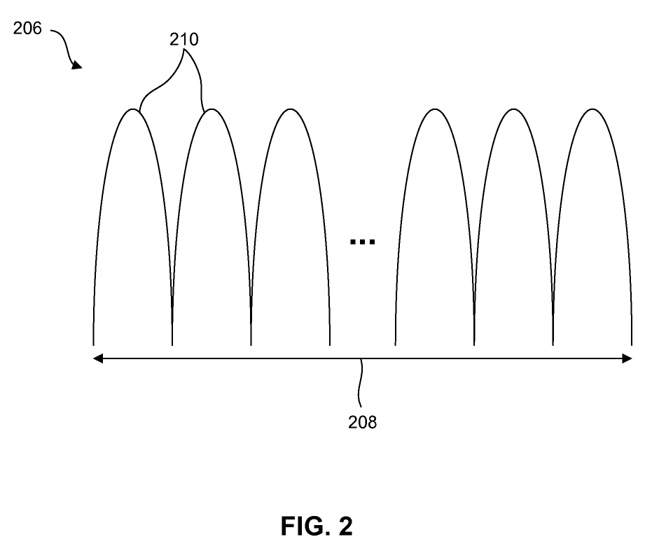

FIG. 2 illustrates some characteristics of a transmission band 208 of an RF communication channel 206 in accordance with an OFDM-based system. As shown, the transmission band 208 may be divided into a number of equally spaced sub-bands 210. As mentioned above, a sub-carrier carrying a portion of the user information is transmitted in each sub-band 210, and every sub-carrier is orthogonal with every other sub-carrier.

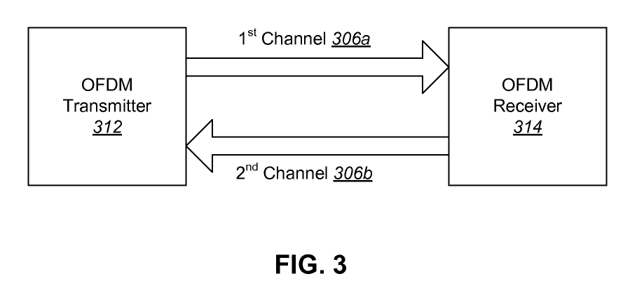

FIG. 3 illustrates communication channels 306 that may exist between an OFDM transmitter 312 and an OFDM receiver 314 according to an embodiment. As shown, communication from the OFDM transmitter 312 to the OFDM receiver 314 may occur over a first communication channel 306a. Communication from the OFDM receiver 314 to the OFDM transmitter 312 may occur over a second communication channel 306b.

The first communication channel 306a and the second communication channel 306b may be separate communication channels 306. For example, there may be no overlap between the transmission band of the first communication channel 306a and the transmission band of the second communication channel 306b.

In addition, the present systems and methods may be implemented with any modulation that utilizes multiple antennas/MIMO transmissions. For example, the present systems and methods may be implemented for MIMO Code Division Multiple Access (CDMA) systems or Time Division Multiple Access (TDMA) systems.

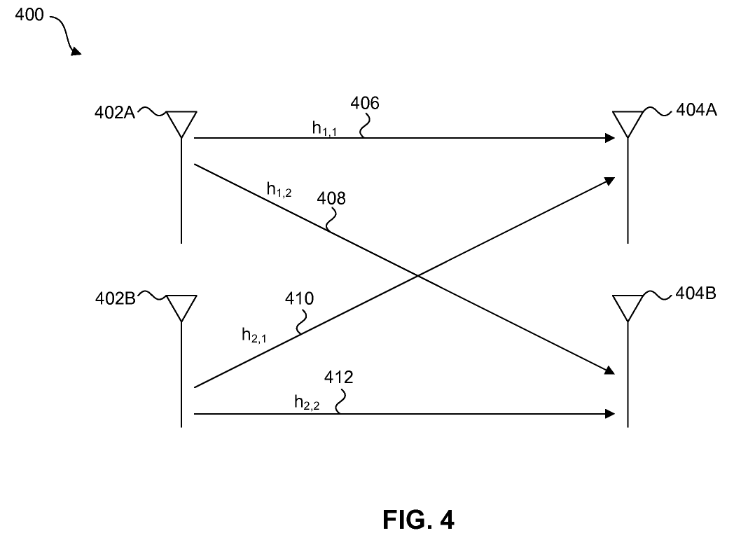

FIG. 4 illustrates one embodiment of a MIMO system 400 that may be implemented with the present systems and methods. The illustrated MIMO system 400 includes a first transmit antenna (Tx₁) 402A and a second transmit antenna (Tx₂) 402B. The system 400 also includes a first receive antenna (Rx₁) 404A and a second receive antenna (Rx₂) 404B. The transmit antennas 402A, 402B may be used to transmit a signal 406, 408, 410, 412 to the receive antennas 404A, 404B.

In single antenna systems, multi-path propagation may be detrimental to the performance of the system. The multiple propagation paths may cause “copies” of a signal to arrive at a receiver at slightly different times. These time delayed signals may then become interference when trying to recover the signal of interest. The MIMO system 400 is designed to exploit the multi-path propagation to obtain a performance improvement. For example, the first receive antenna (Rx₁) 404A may receive a mixture of a first signal 406 and a third signal 410 which are sent from the first transmit antenna (Tx₁) 402A and the second transmit antenna (Tx₂) 402B. The first and third signals 406, 410 may be sent over a first channel h_{1,1} and a second third channel h_{2,1}. The proportion of the first and third signals that is received at the first receive antenna (Rx₁) 404A depends on the transmission channels h_{1,1}, h_{2,1}. A simplified equation for the signal received at the first receive antenna (Rx₁) 404A may be:

Rx₁=(h_{1,1}×Tx₁)+(h_{2,1}×Tx₂) (Equation 2)

The first receive antenna (Rx₁) 404A receives a combination of what was transmitted from the first and second transmit antennas 402A, 402B. The MIMO system 400 may implement various coding schemes that define which signals 406, 408, 410, 412 should be transmitted, and at what times, to enable an original signal to be recovered when it is received in combination with another signal. These coding schemes may be known as “space-time” codes because they define a code across space (antennas) and time (symbols).

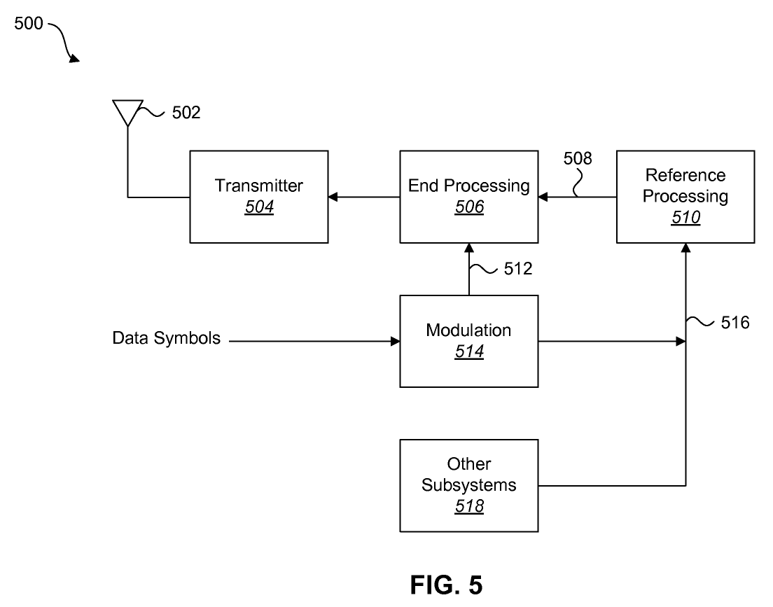

FIG. 5 illustrates a block diagram 500 of certain components in an embodiment of a transmitter 504. Other components that are typically included in the transmitter 504 may not be illustrated for the purpose of focusing on the novel features of the embodiments herein.

Data symbols may be modulated by a modulation component 514. The modulated data symbols may be analyzed by other subsystems 518. The analyzed data symbols 516 may be provided to a reference processing component 510. The reference processing component 510 may generate a reference signal that may be transmitted with the data symbols. The modulated data symbols 512 and the reference signal 508 may be communicated to an end processing component 506. The end processing component 506 may combine the reference signal 508 and the modulated data symbols 512 into a signal. The transmitter 504 may receive the signal and transmit the signal to a receiver through an antenna 502.

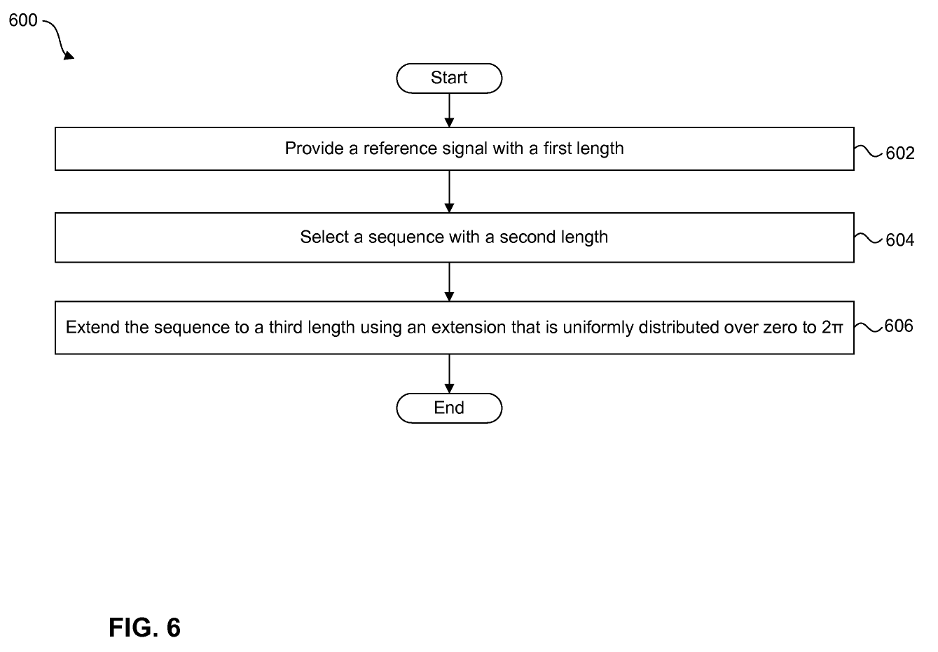

FIG. 6 is a flow diagram illustrating one embodiment of a method 600 for mapping a reference signal. In one embodiment, a reference signal is provided 602. The reference signal may include a first length. A sequence may be selected 604 that includes a second length. In one embodiment, the second length is a prime number and is less than the first length. The sequence may be extended 606 to the same length as the reference signal. The sequence may be extended 606 by using an extension that is uniformly distributed over zero to 2π. In one embodiment, the sequence is extended 606 to a non-prime number. The sequence may include a Zadoff-Chu sequence.

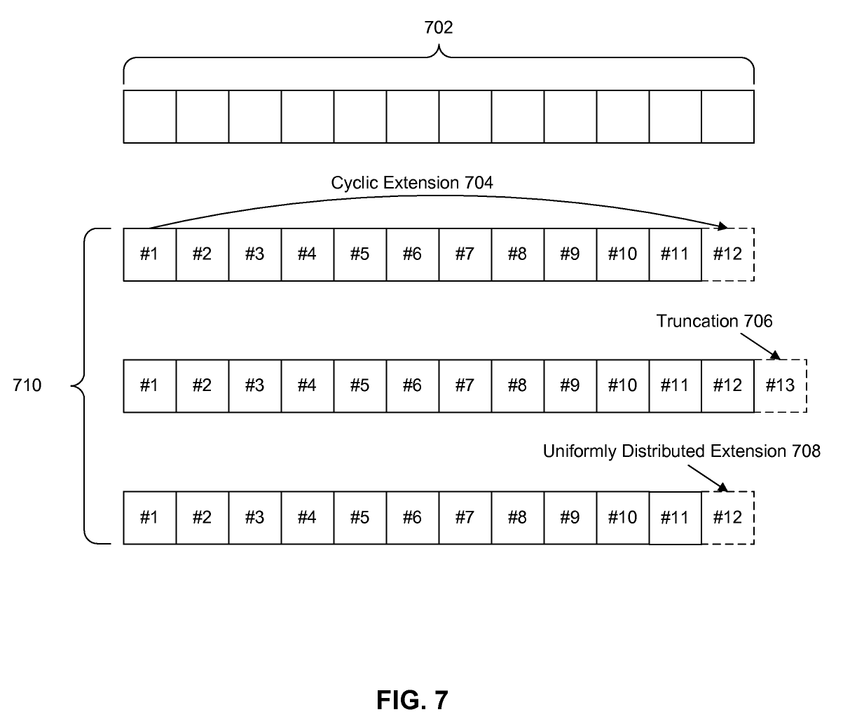

FIG. 7 illustrates an example of mapping a reference signal 702. The reference signal 702 is mapped using three different examples 710 of Zadoff-Chu sequences. Past methods of mapping, such as cyclic extension 704 and truncation 706, are illustrated. In addition, the present systems and methods of extending a Zadoff-Chu sequence through a uniformly distributed extension 708 is also illustrated. In one embodiment, the reference signal 702 has a length of twelve. The length of a Zadoff-Chu sequence may be chosen to fit the reference signal 702 size.

Under the cyclic extension 704 example, the largest Zadoff-Chu sequence length which is shorter than the reference signal 702 is chosen. In this case, a Zadoff-Chu sequence of length eleven is chosen and the twelfth symbol is cyclically extended to the end of the sequence. In one embodiment, the twelfth symbol is obtained by cyclically extending the previous sequence elements from a prime numbered length sequence.

Under the truncation 706 example, the smallest Zadoff-Chu sequence which is longer than the reference signal 702 is chosen. One or more symbols may be truncated so that the sequence is the same length as the reference signal 702. As illustrated, a Zadoff-Chu sequence of thirteen may be chosen and the last symbol may be truncated so that the Zadoff-Chu sequence has a length of twelfth to match the reference signal 702.

Under the present systems and methods of using a uniformly distributed element 708, a Zadoff-Chu sequence is selected and extensions to the sequence are uniformly distributed over zero to 2π. In other words, each extended sequence element in the last position is uniformly distributed in phase from one sequence to the next. By uniformly distributing the extension, the median cross-correlation magnitude between Zadoff-Chu sequences may be reduced. In one embodiment, extending the sequence is implemented in the time domain representation of the Zadoff-Chu sequence. In another embodiment, extending the sequence is implemented in the frequency domain of the Zadoff-Chu sequence.

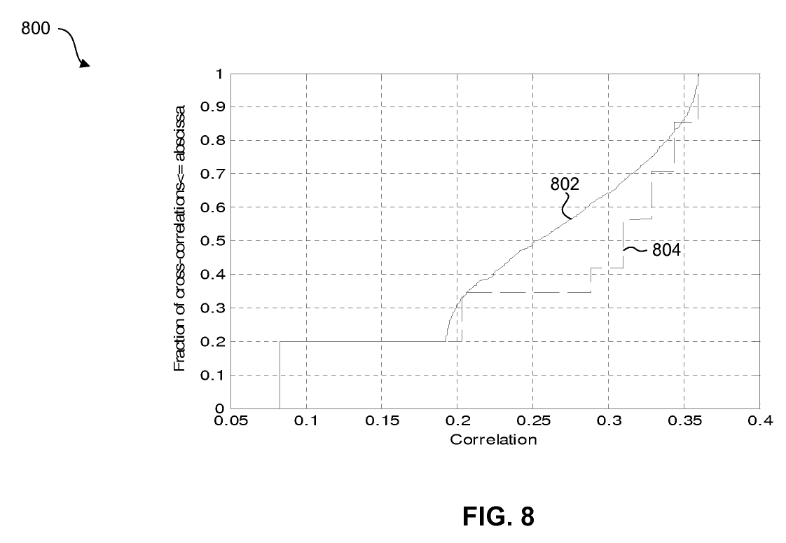

FIG. 8 is a chart 800 illustrating a cumulative distribution function of cross-correlations between Zadoff-Chu sequences using uniformly distributed extensions. The cumulative distribution of cross-correlation magnitudes of 48 length and 11 sequences is illustrated. A cyclic extension plot 804 illustrates the cross-correlation between the sequences when cyclic extension is implemented. A uniform phase extension plot 802 illustrates the cross-correlation between sequences that have been uniformly extended. In one embodiment, the uniform phase extension plot 802 is generated randomly. The randomly generated uniform phase extension plot 802 is uniformly correlated over the entire rest of the Zadoff-Chu sequence, as opposed to simply the first element as in the case of a cyclic extension. As shown by the uniform extension plot 802, there is less cross-correlation (by over 1.5 dB) using uniform extensions as opposed to cyclic extensions.

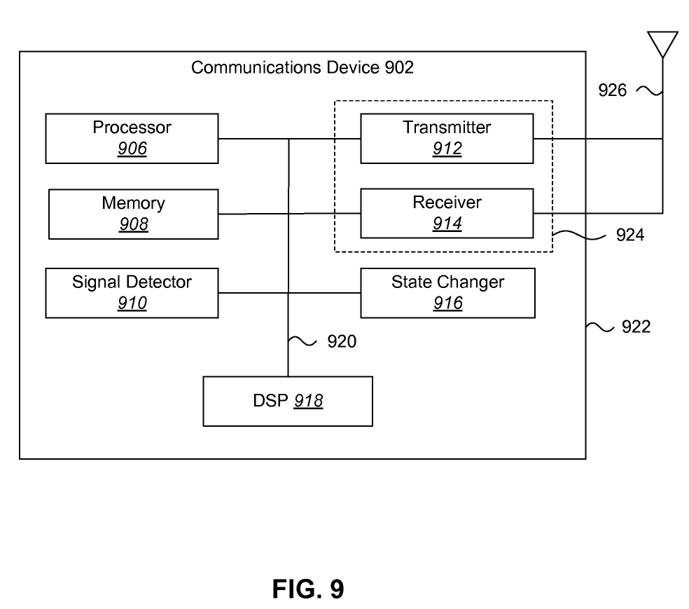

FIG. 9 illustrates various components that may be utilized in a communications device 902. The communications device 902 may include any type of communications device such as a mobile station, a cell phone, an access terminal, user equipment, a base station transceiver, a base station controller, etc. The communications device 902 includes a processor 906 which controls operation of the communications device 902. The processor 906 may also be referred to as a CPU. Memory 908, which may include both read-only memory (ROM) and random access memory (RAM), provides instructions and data to the processor 906. A portion of the memory 908 may also include non-volatile random access memory (NVRAM).

The communications device 902 may also include a housing 922 that contains a transmitter 912 and a receiver 914 to allow transmission and reception of data. The transmitter 912 and receiver 914 may be combined into a transceiver 924. An antenna 926 is attached to the housing 922 and electrically coupled to the transceiver 924. Additional antennas (not shown) may also be used.

The communications device 902 may also include a signal detector 910 used to detect and quantify the level of signals received by the transceiver 924. The signal detector 910 detects such signals as total energy, pilot energy, power spectral density, and other signals.

A state changer 916 controls the state of the communications device 902 based on a current state and additional signals received by the transceiver 924 and detected by the signal detector 910. The communications device 902 may be capable of operating in any one of a number of states.

The various components of the communications device 902 are coupled together by a bus system 920 which may include a power bus, a control signal bus, and a status signal bus in addition to a data bus. However, for the sake of clarity, the various buses are illustrated in FIG. 9 as the bus system 920. The communications device 902 may also include a digital signal processor (DSP) 918 for use in processing signals. The communications device 902 illustrated in FIG. 9 is a functional block diagram rather than a listing of specific components.

As previously mentioned, a plurality of sequences may be used in a cellular system to distinguish the channels of a plurality of mobile terminals at the base station receiver. Thus, it is desirable that these sequences be minimally correlated. The present systems and methods may minimize cross-correlations of a plurality of extended Zadoff-Chu sequences when the sequence length is not a prime number, for use as reference signals in a cellular communication system.

When the sequence length of a Zadoff-Chu sequence is a prime number, its correlation properties are such that the Welch Bound is achieved. However, this property is destroyed in general if the sequence length is not prime. In order to maintain the sequence properties, cyclic extension has been utilized (as shown in FIG. 7), where the last sequence elements are obtained by cyclically extending the previous sequence elements from a prime numbered length sequence.

By implementing extensions that are uniformly distributed over (0, 2π), (that is, each extended sequence element in the last position is uniformly distributed in phase from one sequence to the next) however, the median cross-correlation mapping may be reduced, as a cumulative distribution function of cross-correlation shown in FIG. 8.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed is:

1. A method for mapping a reference signal, the method comprising:
providing a reference signal with a first length;
selecting a sequence with a second length, wherein the second length is a prime number; and
extending the sequence to a third length using an extension that is uniformly distributed over zero to 2π.

2. The method of claim 1, further comprising extending the sequence to a non-prime number using the extension that is uniformly distributed over zero to 2π.

3. The method of claim 1, wherein the second length is less than the first length.

4. The method of claim 1, wherein the third length is equal to the first length.

5. The method of claim 1, wherein the sequence is a Zadoff-Chu sequence.

6. The method of claim 1, further comprising extending the sequence in a time domain representation of the sequence.

7. The method of claim 1, further comprising extending the sequence in a frequency domain representation of the sequence.

8. The method of claim 1, further comprising extending a first sequence with an extension that is uniformly distributed in phase from an extension of a second sequence.

9. The method of claim 1, further comprising cyclically extending the sequence using the extension that is uniformly distributed over zero to 2π.

10. The method of claim 1, further comprising providing a set of reference signals to cover a plurality of sectors of a cell.

11. A system that is configured to map a reference signal, the system comprising:
a processor;
memory in electronic communication with the processor;
instructions stored in the memory, the instructions being executable to:
provide a reference signal with a first length;
select a sequence with a second length, wherein the second length is a prime number; and
extend the sequence to a third length using an extension that is uniformly distributed over zero to 2π.

12. The system of claim 11, wherein the instructions are further executable to extend the sequence to a non-prime number using the extension that is uniformly distributed over zero to 2π.

13. The system of claim 11, wherein the second length is less than the first length.

14. The system of claim 11, wherein the third length is equal to the first length.

15. The system of claim 11, wherein the sequence is a Zadoff-Chu sequence.

16. The system of claim 11, wherein the instructions are further executable to extend the sequence in a time domain representation of the sequence.

17. The system of claim 11, wherein the instructions are further executable to extend the sequence in a frequency domain representation of the sequence.

18. The system of claim 11, wherein the instructions are further executable to extend a first sequence with an extension that is uniformly distributed in phase from an extension of a second sequence.

19. A computer-readable medium comprising executable instructions for mapping a reference signal, the instructions being executable to:
provide a reference signal with a first length;
select a sequence with a second length, wherein the second length is a prime number; and
extend the sequence to a third length using an extension that is uniformly distributed over zero to 2π.

20. The computer-readable medium of claim 19, wherein the instructions are further executable to extend the sequence to a non-prime number using the extension that is uniformly distributed over zero to 2π.
